(19) United States
(12) Patent Application Publication
(10) Pub. No.: US 2008/0215469 A1
(43) Pub. Date: Sep. 4, 2008

(54) Consumer Finance Method and System

(76) Inventor: James Rickard Maloney, Queensland (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/916,338

(22) PCT Filed: Jun. 1, 2006
(86) PCT No.: PCT/AU06/00744

§ 371 Date: Dec. 3, 2007

(30) Foreign Application Priority Data
Jun. 1, 2005 (AU) 2005902822
Oct. 21, 2005 (AU) 2005905848

(51) Int. Cl. G06Q 20/00; G06Q 10/00; G06Q 30/00; G06Q 40/00

(52) U.S. Cl. 705/34; 705/40; 705/38

(57) ABSTRACT

A consumer finance method and system financing a purchase including the steps of providing new goods or services to at least partially replace used goods or services which the customer is currently using to a customer at a purchase price; and collecting at least the amount of the purchase price from the customer in a plurality of installments, the amount of each installment calculated as the amount which the customer would have paid for the used goods or services based on historical information.

### FIELD OF THE INVENTION

The present invention relates to methods of financing customer purchases and in particular, to computer implemented methods of financing purchases using a notional installment payment amount based on an amount other than the purchase price of the purchase.

### BACKGROUND ART

Methods for providing consumer finance, systems and computer programs therefor have been previously developed.

A traditional fixed-rate loan payment consists of two parts: (1) interest on the loan and (2) payment towards the principal, or unpaid balance of the loan.

Many people are surprised to learn, however, that the amount paid towards the interest and principal components of the loan varies dramatically over time. This is because loans work in such a way that the early payments are primarily in interest, and the later payments are primarily towards the principal.

To help calculate monthly payments for loans based on different interest rates, lenders long ago developed what are known as “amortization tables.” These tables also make it fairly easy to calculate how much money of each payment is interest and how much goes towards the principal balance.

The most common type of loan for goods is a loan to purchase real estate or property. It may be convenient to understand prior art systems with reference to an example.

For example, calculating the principal and interest for the very first monthly payment of a 30-year, $100,000 loan at 7.5 percent interest. According to the amortization tables, the monthly payment on this loan is fixed at $699.21.

The first step is to calculate the annual interest by multiplying $100,000×0.075 (7.5%). This equals $7,500, and then dividing by 12 (for the number of months in a year), which equals $625.

Subtracting $625 from the monthly payment of $699.21, it can be seen that:
$625° F. THE FIRST PAYMENT IS INTEREST
$74.21° F. THE FIRST PAYMENT GOES TOWARDS THE PRINCIPAL

Next, subtracting $74.21 (the first principal payment) from the $100,000 of the loan, a new unpaid principal balance of $99,925.79 is arrived at. To determine the next month's principal and interest payments, the steps already described are repeated.

Thus, multiplying the new principal balance ($99,925.79) times the interest rate (7.5%) to get an annual interest payment of $7,494.43. Divided by 12, this equals $624.54. So during the second month's payment:
$624.54 IS INTEREST
$74.67 GOES TOWARDS THE PRINCIPAL

The major problem with the calculation of the repayments owed under the loan agreement is that the repayments are calculated arbitrarily and in proportion to the original amount loaned and the net present value of the future loan repayment stream.

Another disadvantage of the prior art loan repayment systems is that when a loan is sought for an apparatus, the apparatus often only has a limited life and must be replaced by obtaining a new loan to buy new or replacement goods. There is not generally a lasting benefit of purchasing the goods generally due to the nature of the goods.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a consumer finance method and system, which may at least partially overcome at least one of the above-mentioned disadvantages or provide the consumer with a useful or commercial choice.

In one form, the invention resides in a consumer finance method and system including the steps of

providing new goods or services to at least partially replace used goods or services which the customer is currently using to a customer at a purchase price; and

collecting at least the amount of the purchase price from the customer in a plurality of installments, the amount of each installment calculated as the amount which the customer would have paid for the used goods or services based on historical information.

The present invention finds particular application in the field of using alternative energy sources to power appliances. Whilst described with this aspect in mind, it is anticipated that the method of the invention may also find application in other circumstances such as the supply of heat to a building for example. Systems similar to the present method have been utilised in the past but the prior systems are conventional credit loan systems.

In particular, the method of the present invention may be to provide an alternative or renewable energy collection or generation apparatus or system to a user to power the user's appliances at minimal upfront cost to the user. The method would then be used to calculate the user's repayments of the purchase price of the alternative or renewable energy collection or generation apparatus or system or balance thereof, according to the amount which the user would have paid for electricity supplied from an electricity supply company to power the appliances over a period.

As stated, the method of the present invention has particular application in the field of renewable energy sources such as solar, wind or tidal energy sources for example. The method also finds application in situations where more environmentally friendly devices can be purchased to replace less environmentally friendly devices, such as water saving devices in a home or business, hybrid or environmentally friendly vehicles over petrol-powered vehicles or gas air-conditioners to replace electrically powered devices.

In another form, the invention resides in a consumer finance method and system including the steps of

providing an alternative or renewable energy collection or generation apparatus or system to at least partially replace electricity supplied from an electricity supply company which the customer is currently using, to a customer at a purchase price under a credit arrangement;

establishing a credit contract between a credit provider and the purchaser of the alternative or renewable energy collection or generation apparatus or system and

using a computer to calculate a repayment plan for at least the purchase price, based on the amount which the customer would have paid for the electricity supplied from an electricity supply company.

The repayment plan will typically be based on the repayment of the purchase price over an extended period. The purchase price will generally include an amount for the cost of replacing the hardware of the alternative or renewable energy collection or generation apparatus or system alternative or renewable energy collection or generation apparatus or system plus an amount to cover the cost of installation of the apparatus or system and connection to a building electricity grid.

Electricity supply companies generally send accounts to be paid by the user at specific periods, normally on a monthly, bimonthly or quarterly basis. The method of the present invention may use the historical usage data of the electricity supply company or the usage data of the electricity from the alternative or renewable energy collection or generation apparatus or system as the basis for calculating the repayments. At the end of the contract, the purchase price plus typically a suitable opportunity cost of the loaned funds will have been recovered by the provider of the finance or credit and thereafter, the purchaser saves the amount which would have been outlayed on the electricity supply prior to the purchase.

According to a preferred aspect of the present invention, the repayments will be calculated to substantially match the historical spending of the customer on electricity supply. The credit amount will then be reduced by the amount paid by the customer in each repayment. Once the credit amount has been paid plus any interest and/or charges levied by the credit provider, the customer will suitably have no further expenses in regard to electricity supply, and may continue to benefit from the savings resulting from the installed alternative or renewable energy collection or generation apparatus or system and not having to pay for supply from a utilities company.

In still another form, the invention resides in a consumer finance method and system including the steps of

providing an alternative or renewable energy collection or generation apparatus or system to at least partially replace utilities supplied from a utilities supply company which the customer is currently using, to a customer at a purchase price under a credit arrangement;

establishing a credit contract between a credit provider and the purchaser of the alternative or renewable energy collection or generation apparatus or system and

using a computer to calculate a repayment plan for at least the purchase price, based on the amount which the customer would have paid for the utilities supplied from an utilities supply company.

Typically, an amount may be added to the actual replacement cost of the hardware of the alternative or renewable energy collection or generation apparatus or system to account for the opportunity cost of the credit provider lending the funds to the purchaser, and this opportunity cost amount may include but not be limited to such charges as interest, charges for the set-up and administration of the credit contract, government fees and profit for the credit provider and the like.

As stated previously, the method of the present invention and particularly preferred embodiments of the present invention, finds application in the field of providing electricity or hot water utilities to a building. As a result of the utilization of the present method, the purchaser purchases an alternative or renewable energy collection or generation apparatus or system, pays a negligible upfront payment, pays the alternative or renewable energy collection or generation apparatus or system off at a rate no larger than that which the purchaser was paying already for the supply of electricity from a utilities company, and at the end of the credit contract, the purchaser does not have to pay at all for further supply, provided that the alternative or renewable energy collection or generation apparatus or system is able to supply sufficient energy to meet the demand. Any usage made of the alternative or renewable energy collection or generation apparatus or system after the purchaser has paid the credit contract out is a saving to the purchaser. The savings will typically be ongoing until the purchaser is forced to replace the alternative or renewable energy collection or generation apparatus or system.

The credit provider may be the provider or installer of the alternative or renewable energy collection or generation apparatus or system or they may be a member of an established and/or regulated group of credit providers such as a bank or credit agency. The credit provider may employ the installers as sub-contractors or according to another arrangement.

The alternative or renewable energy collection or generation apparatus or system may include solar collection equipment. The system or apparatus will also generally include all fittings and fixtures, for example connection equipment, required to link the collection system or apparatus to the building utilities grid. The apparatus or system may be used as a part of a system to at least partially replace electric or gas hot water systems. The apparatus may be used to replace current electric or gas hot water which use electricity or gas to heat the water. Typically, the solar collection equipment may be used to heat the water instead of the electricity or gas.

Typically, the repayment plan includes a series of repayments. Preferably, the repayments may be calculated according to the purchaser's historical payments to an electricity or gas supply company. There may be variations in the payment amounts to account for seasonal variations in usage patterns or the repayments may be an average amount calculated over a period, for example six months or one year. Suitably, the credit contract will have no fixed term in which the purchase price is to be paid out but instead the term will be calculated according to the historical pattern of use of the purchaser. Preferably, the credit contract may be paid in full prior to the expiry of any warranty period associated with the alternative or renewable energy collection or generation apparatus or system.

The method of the present invention is easily adaptable to situations other than the supply of electricity. For example, the method can be applied to the provision of equipment or a system to heat a building using solar energy, cooling a building by diverting flowing water or wind or electricity generated using tidal electricity generating apparatus.

The method of the present invention is preferably a computer-implemented method. A network of computers may be utilized or a global computer network such as the Internet may be utilized.

In still another form, the invention resides in a consumer finance method and system including the steps of

providing new goods or services to at least partially replace goods or services which the customer is currently using to a customer at a purchase price; and

collecting at least the amount of the purchase price from the customer in a plurality of installments, the amount of each installment calculated as the amount which the customer would have paid for the goods or services based on historical information.

In this form, the method of the invention may be used to fund a purchase of virtually any good or service. The invention is particularly useful for the purchase of expensive items, appliances or equipment having a relatively long, but limited lifespan. Examples of these types of goods are white goods, water tanks for buildings and any other goods which can be used to minimize environmental impacts.

The invention can be used to purchase goods or services with a minimum or absence of up-front costs.

### DETAILED DESCRIPTION OF THE PREFERRED EMBODIMENT

According to a preferred embodiment of the present invention, a method of financing purchases and calculating repayments is provided.

In the most preferred embodiment of the invention, a method of financing a purchase for providing an alternative or renewable energy collection or generation apparatus or system to at least partially replace electricity supplied from an electricity supply company to heat hot water which the customer is currently using is provided. The alternative or renewable energy collection or generation apparatus or system will be provided to a customer at a purchase price under a credit arrangement.

A credit contract will be established between a credit provider and the purchaser of the alternative or renewable energy collection or generation apparatus or system and a repayment plan for the purchase price is then calculated using a computer, based on the amount which the customer would have paid for the electricity supplied from an electricity supply company on historical basis.

The repayment plan is based on the repayment of the purchase price over an extended period. The purchase price upon which the credit contract is based will include an amount for the cost of replacing the hardware of the alternative or renewable energy collection or generation apparatus or system alternative or renewable energy collection or generation apparatus or system plus an amount to cover the cost of installation of the apparatus or system and connection to a building electricity grid.

Electricity supply companies generally send accounts to be paid by the user at specific periods, normally on a monthly, bimonthly or quarterly basis and these accounts include a tariff or amount for electricity used to heat water for use. The preferred embodiment of the method of the present invention uses the historical usage data of the electricity supply company as the basis for calculating the repayments for the cost of purchasing a new system which will ultimately result in the purchaser saving money. At the end of the contract, the purchase price will have been recovered by the provider of the finance or credit and thereafter, the purchaser saves the amount which would otherwise have been outlayed on the electricity supply prior to the purchase.

According to a preferred aspect of the present invention, the repayments will be calculated to substantially match the historical spending of the customer on electricity supply. The credit amount will then be reduced by the amount paid by the customer in each repayment. Once the total purchase price has been paid, the customer will have no further expenses in regard to electricity supply, and may continue to benefit from the savings resulting from the installed alternative or renewable energy collection or generation apparatus or system and not having to pay for supply from a utilities company.

An amount may be added to the actual replacement cost of the hardware and installation of the alternative or renewable energy collection or generation apparatus or system to account for the opportunity cost of the credit provider lending the funds to the purchaser, and this opportunity cost amount may include but not be limited to such charges as interest, charges for the set-up and administration of the credit contract, government fees and profit for the credit provider and the like.

As a result of the utilization of the present method, the purchaser purchases an alternative or renewable energy collection or generation apparatus or system, pays a negligible upfront payment, pays the alternative or renewable energy collection or generation apparatus or system off at a rate no larger than that which the purchaser was paying already for the supply of electricity from a utilities company, and at the end of the credit contract, the purchaser does not have to pay for further supply. Any usage made of the alternative or renewable energy collection or generation apparatus or system after the purchaser has paid the credit contract out, represents a saving to the purchaser. The savings will typically be ongoing until the purchaser is forced to replace the alternative or renewable energy collection or generation apparatus or system.

The credit provider may be the provider or installer of the alternative or renewable energy collection or generation apparatus or system or they may be a member of an established and/or regulated group of credit providers such as a bank or credit agency.

The alternative or renewable energy collection or generation apparatus or system of the preferred embodiment includes solar collection equipment. The system or apparatus also includes all fittings and fixtures, for example connection equipment, required to link the collection system or apparatus to the building utilities grid. The apparatus or system of the preferred embodiment is used as a part of a system to at least partially replace electric or gas hot water systems.

The repayment plan includes a series of repayments. The repayments are calculated according to the purchaser's historical payments to an electricity or gas supply company. There may be variations in the payment amounts to account for seasonal variations in usage patterns or the repayments may be an average amount calculated over a period, for example six months or one year.

The method of the preferred embodiment is a computer-implemented method. A network of computers may be utilized or a global computer network such as the Internet may be utilized.

The method of the preferred embodiment may be more clearly illustrated using an example. In the example, the alternative or renewable energy collection or generation apparatus or system costs an initial $2000 and an interest rate of 5% per annum is applied to the amount. This results in an annual interest amount in the first year of the contract of $100. The purchaser has a historical usage pattern whereby $100 per quarter is spent on electricity for the heating of water.

At $100 per quarter, the purchaser pays off $400 in the first year leaving a balance owing of $1700 at the end of year one. Using a simple mathematic model, we can see that an application of the method results in a balance at the end of the second year of $1700+(5% of $1700)−$400 which equals $1385. At the end of the third year, the balance owing will be $1054.25, at the end of the fourth year, $706.96, at the end of the fifth year, $342.31 and the credit contract will be paid out fully in the sixth year. Any savings after this point, that is the $400 per year that would otherwise have been paid for electricity to heat the water, will be a saving to the customer.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A consumer finance method and system for financing a purchase including the steps of providing new goods or services to at least partially replace used goods or services which the customer is currently using to a customer at a purchase price; and collecting at least the amount of the purchase price from the customer in a plurality of installments, the amount of each installment calculated as the amount which the customer would have paid for the used goods or services based on historical information.

2. A consumer finance method and system for financing a purchase including the steps of providing an alternative or renewable energy collection or generation apparatus or system to at least partially replace electricity supplied from an electricity supply company which the customer is currently using, to a customer at a purchase price under a credit arrangement; establishing a credit contract between a credit provider and the purchaser of the alternative or renewable energy collection or generation apparatus or system and using a computer to calculate a repayment plan for at least the purchase price, based on the amount which the customer would have paid for the electricity supplied from an electricity supply company.

3. A consumer finance method and system according to claim 1 wherein the repayments are calculated to substantially match the historical spending of the customer on electricity supply.

4. A consumer finance method and system for financing a purchase including the steps of providing an alternative or renewable energy collection or generation apparatus or system to at least partially replace utilities supplied from a utilities supply company which the customer is currently using, to a customer at a purchase price under a credit arrangement; establishing a credit contract between a credit provider and the purchaser of the alternative or renewable energy collection or generation apparatus or system and using a computer to calculate a repayment plan for at least the purchase price, based on the amount which the customer would have paid for the utilities supplied from an utilities supply company.

5. A consumer finance method and system according to claim 1 wherein the alternative or renewable energy collection or generation apparatus or system includes solar collection equipment.

6. A consumer finance method and system according to claim 1 wherein the credit contract has no fixed term in which the purchase price is to be paid out but the term is calculated according to the historical pattern of use of the purchaser.

7. A consumer finance method and system according to claim 1 wherein the method is a computer-implemented method.

8. A consumer finance method and system according to claim 7 wherein the computer implements the method and produces a list of scheduled repayments which govern the amount and timing of the repayments.

9. A consumer finance method and system according to claim 2 wherein the method is a computer-implemented method and once the list of repayments has been produced, the list is imported into a record keeping system for monitoring by the credit provider.

10. A consumer finance method and system for financing a purchase including the steps of providing new goods or services to at least partially replace goods or services which the customer is currently using to a customer at a purchase price; and collecting at least the amount of the purchase price from the customer in a plurality of installments, the amount of each installment calculated as the amount which the customer would have paid for the goods or services based on historical information.
